(19) United States
(12) Patent Application Publication
(10) Pub. No.: US 2014/0292575 A1
(43) Pub. Date: Oct. 2, 2014

(54) METHOD FOR FORMATION OF A SIGNALS ARRAY FROM A RECEIVER OF SIGNALS FROM A SATELLITE NAVIGATION SYSTEM IN ORDER TO IMPROVE ITS RESISTANCE TO SCRAMBLING OR INTERFERENCE

(71) Applicant: THALES, Neuilly-Sur-Seine (FR)

(72) Inventors: Nicolas Martin, Bourg Les Valence (FR); Jean-Michel Perre, St. Peray (FR); Vincent Chopard, Tournon Sur Rhone (FR)

(73) Assignee: THALES, Neuilly-Sur-Seine (FR)

(21) Appl. No.: 14/226,019

(22) Filed: Mar. 26, 2014

(30) Foreign Application Priority Data
Mar. 27, 2013 (FR) 1300714

(51) Int. Cl. G01S 19/21

(52) U.S. Cl. CPC G01S 19/21
USPC 342/357.59

(57) ABSTRACT

Method for formation of a signals array from a receiver (20) of signals from a satellite navigation system in order to improve the resistance to scrambling or interference, the receiver (20) being equipped with an antenna (21) having several controlled reception pattern sensors, comprising a step consisting in determining the attitude of the antenna in a TGL reference frame centred on the receiver, by iterative determination of the attitude angles of the antenna yielding the maximum of the sum of the energies of the weighted sums of the signals received by the sensors at the output of the correlators of the processing channel respectively associated with the satellites, the weighting coefficients of the weighted sums being calculated from the attitude angles considered at each iteration and from the known positions of the satellites in the TGL reference frame.

The present invention relates to a method for formation of a signals array for a receiver of signals from a satellite navigation system in order to improve its resistance to scrambling or interference, and to an associated receiver.

Radio navigation by satellites allows the position of a receiver to be obtained by a solution akin to triangulation, using the pseudo-distances measured from the signals sent by the satellites.

The determination of the attitude of an aircraft using signals from a satellite navigation system or GNSS, as acronym for “Global Navigation Satellite System”, received over several antenna sensors, belongs to the prior art. The techniques implemented are based on the long-known principle of radiogoniometry.

The first methods used implement carrier phase measurements produced by independent signal processing operations between the antenna sensors and between the satellites, with a removal of any ambiguity allowing the coordinates to be determined in the ECEF (acronym for “Earth Centred Earth Fixed”) reference frame, or in the TGL reference frame (set of local geographic axes, North, East, Vertical reference frame centred on the position of the receiver) for each vector connecting two phase centres of two sensors.

These methods are appropriate when the aim is to determine a precise attitude with a simple architecture (no specific signal processing operation). In order to obtain a sufficient precision, sensors separated by several times the wavelength are used (there are then said to be multiple antennas), to the detriment of the removal of the ambiguity which is more difficult to achieve (risk of errors). These methods do not offer any particular improvement in terms of resistance to scrambling or interference.

Other solutions use a determination of the directions of arrival of the signals in a reference frame linked to the antenna based on the MUSIC (acronym for “Multiple Signal Classification”) or ESPRIT (acronym for “Estimation of Signal Parameters via Rotational Invariance Techniques”) methods carried out satellite by satellite, with a specific operation for processing the signal. Subsequently, the receiver determines the attitude angles yielding, by calculation based on the directions of the satellite in the TGL reference frame, the same directions of arrival in a reference frame linked to the antenna as those obtained using the received signals.

This step consists in a search over the attitude angles with a likelihood criterion calculated by comparing measured and calculated directions of arrival. This search can be accelerated using the gradient method.

These methods are more adapted to antennas known as CRPA (for “Controlled Reception Pattern Antenna”) with a greater number of sensors (at least 4) and which are closer together. They do not aim to improve the robustness to scrambling or interference.

In a GNSS signal receiver, the determination of the attitude may have several objectives, such as the detection of a decoy attempt, the determination of the direction of an interference source in the TGL reference frame, or the formation of an array.

The array formation consists in carrying out, for each satellite direction, a weighted sum of the signals from the various sensors of the antenna, in such a manner as to maximize the power of the useful signal received from the satellite and hence to obtain a better signal-to-noise ratio in the tracking loops. The signals array formation allows the noise on the measurements to be minimized, the effect of the multiple paths (reflected signals arriving from different directions) to be reduced and the resistance to scrambling or interference of the tracking loops to be increased.

The signals array formation requires the knowledge of the direction of the satellites in a reference frame linked to the antenna in order to calculate the complex weighting coefficients for the weighted sums. In the ideal case, the receiver disposes of an inertial aid which enables it to know the attitude of the antenna in the TGL reference frame and hence to calculate the direction of the satellites in the antenna reference frame starting from the positions of the satellites in the TGL which may be calculated by means of the almanacs transmitted via the satellite signals.

One aim of the invention is to determine the attitude of the antenna in order to effect the signals array formation without the need for an external aid.

The principle of the invention is to directly recover the attitude angles of the antenna based on the received signals without going through the determination of the directions of arrivals of the satellite signals.

According to one aspect of the invention, a method is provided for the formation of a signals array for a receiver of a signal from a satellite navigation system in order to improve the resistance to scrambling or interference, the receiver being equipped with a multi-sensor controlled reception pattern antenna array, comprising a step consisting in determining the attitude of the antenna in a TGL reference frame centred on the receiver, by iterative determination of the attitude angles of the antenna yielding the maximum of the sum of the energies of the weighted sums of the signals received by the sensors at the output of the correlators of the processing channels respectively associated with the satellites, the weighting coefficients of the weighted sums being calculated based on the attitude angles considered at each iteration and on the known positions of the satellites in the TGL reference frame.

The positions of the satellites in the TGL reference frame may, for example, be known by virtue of the almanacs transmitted via the signals from the satellites

Thus, no aid external to the receiver is needed, that would require costly and bulky equipment.

In one embodiment, discriminators are used for parameters representative of the directions of arrival of the satellite signals in a reference frame linked to the antenna.

Thus, advantage is taken of the redundancy of the satellites in order to resolve the attitude angles and to improve the robustness to scrambling or interference.

According to one embodiment, the said parameters representative of the directions of arrival of the satellite signals in a reference frame linked to the antenna comprise direction cosines or elevation and azimuthal angles.

In one embodiment, a method based on an observational model for the relationship between the parameters representative of the directions of arrival of the satellite signals and the attitude angles of the antenna.

Thus, the attitude angles can be directly resolved without going through the determination of the directions of the satellites in the reference frame linked to the antenna, and hence fully taking advantage of the redundancy of the satellites in order to improve the robustness to scrambling or interference.

According to one embodiment, the solution of the said observational model implements a Kalman filtering or a least squares method.

According to another aspect of the invention, a receiver is provided for a signal from a satellite navigation system, equipped with an antenna using controlled reception pattern sensors, comprising means for forming signals arrays in order to improve the resistance to scrambling or interference, comprising means for determining the attitude of the antenna in a TGL reference frame centred on the receiver, by iterative determination of the attitude angles of the antenna yielding the maximum of the sum of the energies of the weighted sums of the signals received by the sensors at the output of the correlators of the processing channels respectively associated with the satellites, the weighting coefficients of the weighted sums being calculated from the attitude angles considered at each iteration and from the known positions of the satellites in the TGL reference frame.

The invention will be better understood upon studying a few embodiments described by way of non-limiting examples illustrated by the appended drawings in which:

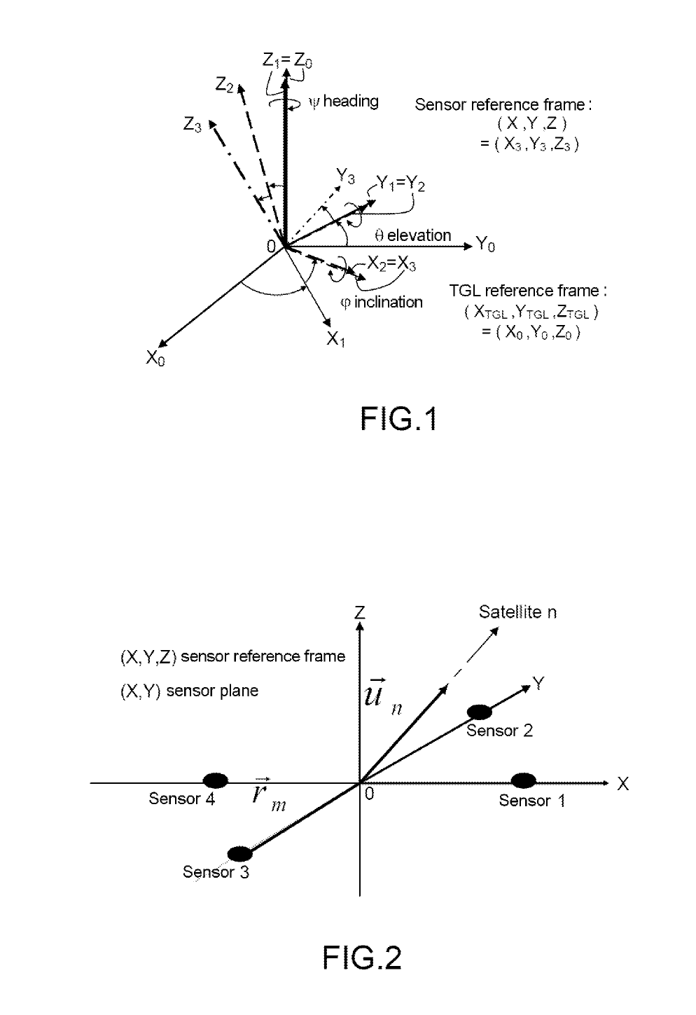

FIG. 1 illustrates the Euler angles;

FIG. 2 illustrates an antenna with four sensors;

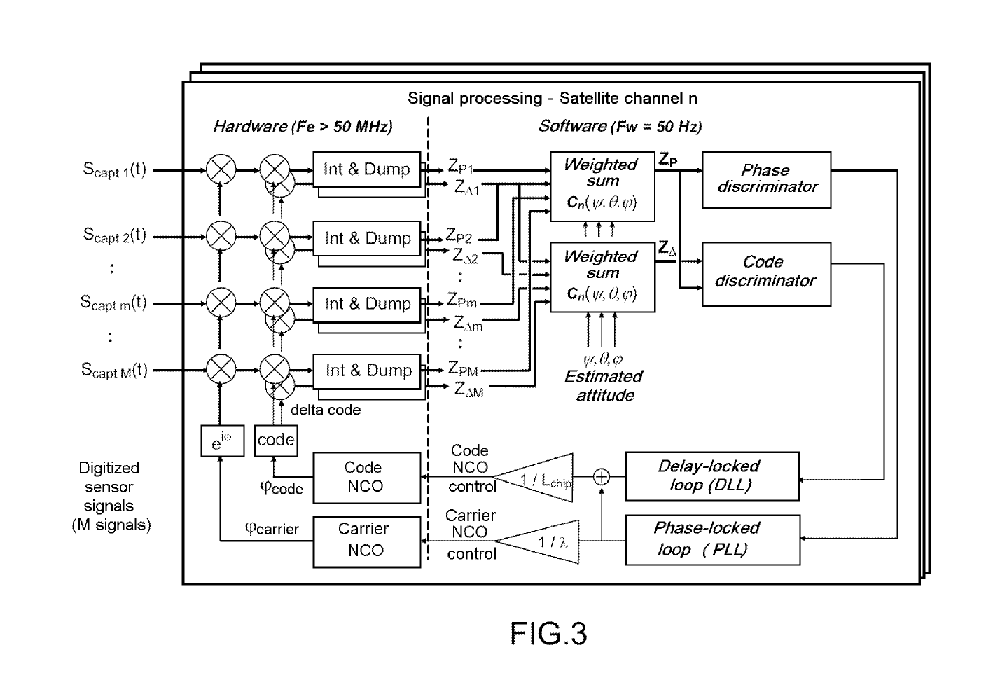

FIG. 3 illustrates a demodulation with array formation and tracking loops;

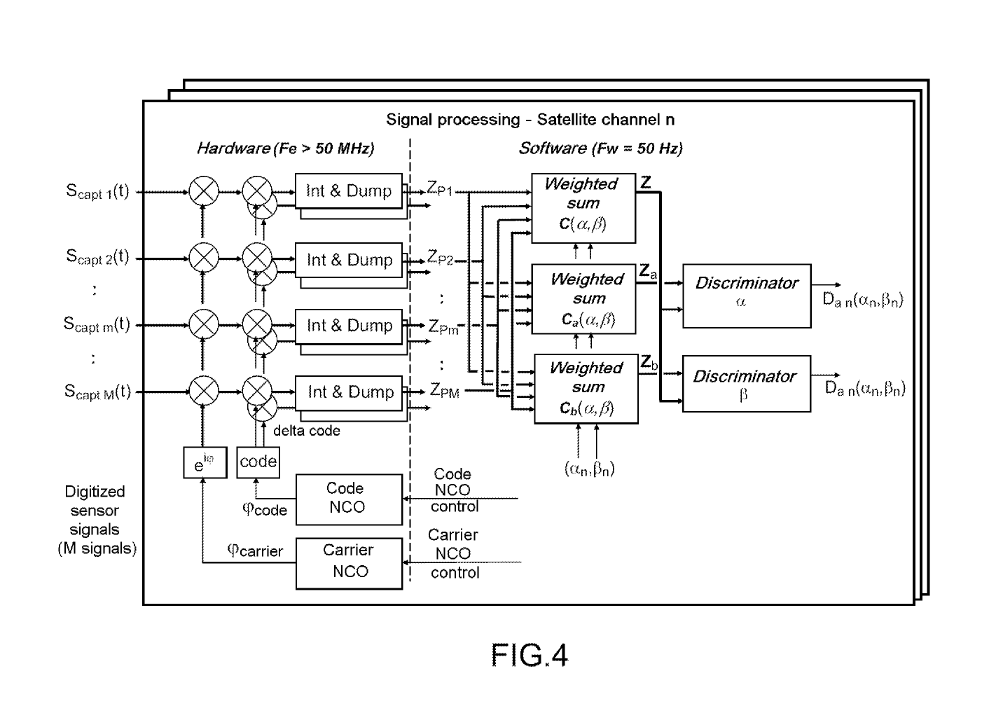

FIG. 4 illustrates a demodulation with array formation and discriminator of the direction cosines;

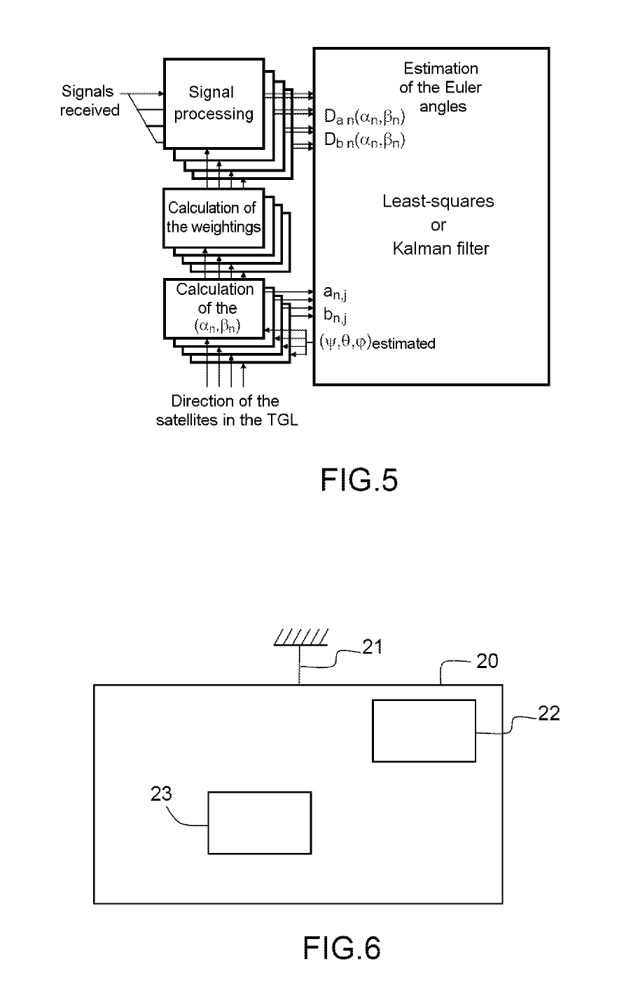

FIG. 5 illustrates schematically the method according to one aspect of the invention;

and FIG. 6 illustrates a receiver according to one aspect of the invention.

In fact, the method boils down to looking for the attitude angles that yield the maximum of the sum over all the satellites of the energies of the weighted sums of the signals. This method uses an extended Kalman filter which allows the non-linear equations between the Euler angles and the signals at the demodulation output to be solved.

Owing to the fact that there are fewer unknowns to solve (3 angles instead of 2 angles per satellite) for the same total number of measurements, this solution is more robust to scrambling or interference than the method consisting in seeking the directions of arrival of the signals satellite by satellite. It therefore allows the array formation process to be continued with a higher level of interference.

The position of the satellites (X_{n TGL}, Y_{n TGL}, Z_{n TGL}) is calculated in a first TGL reference frame (set of local geographic axes, North, East, Vertical reference frame centred on the position of the receiver) centred on the receiver using the position of the receiver and the position of the satellite. The positions of the satellites are known by virtue of the almanac data, contained in the navigation messages transmitted by the signals emitted by the satellites.

The direction vector between the antenna of the receiver and the satellite with index n of the satellite navigation system, in the first TGL reference frame, is by definition equal to:

$${\vec{u}}_{n TGL} {=}^{def} [ \begin{matrix}{X}_{n TGL} \\ {Y}_{n TGL} \\ {Z}_{n TGL}\end{matrix} ] / ρ$$

The denominator ρ represents the distance separating the antenna of the receiver and the satellite n, which is independent of the reference frame:

$$ρ {=}^{def} \sqrt{{X}_{n}^{2} + {Y}_{n}^{2} + {Z}_{n}^{2}} = \sqrt{{X}_{n TGL}^{2} + {Y}_{n TGL}^{2} + {Z}_{n TGL}^{2}}$$

Throughout the present application, the presence of an index “def” above an equality sign in a mathematical expression means an equality by definition and not by consequence.

As in FIG. 1, the attitude of the antenna is shown with respect to the first TGL reference frame by virtue of the Euler angles: Heading (ψ), Elevation (θ) and Inclination (φ). These angles allow the reference transfer matrix M(ψ, θ, φ) from the first TGL reference frame to the second reference frame linked to the antenna or to the antenna (idem) sensors to be constructed:

$$M ( ψ , θ , ϕ ) {=}^{def} [ \begin{matrix}1 & 0 & 0 \\ 0 & cos ϕ & - sin ϕ \\ 0 & sin ϕ & cos ϕ\end{matrix} ] [ \begin{matrix}cos θ & 0 & - sin θ \\ 0 & 1 & 0 \\ sin θ & 0 & cos θ\end{matrix} ] [ \begin{matrix}cos ψ & sin ψ & 0 \\ - sin ψ & cos ψ & 0 \\ 0 & 0 & 1\end{matrix} ] \\ [ \begin{matrix}{X}_{sensor} \\ {Y}_{sensor} \\ {Z}_{sensor}\end{matrix} ] = M ( ψ , θ , ϕ ) \cdot [ \begin{matrix}{X}_{TGL} \\ {Y}_{TGL} \\ {Z}_{TGL}\end{matrix} ]$$

The direction vector between the antenna of the receiver and the satellite with index n of the satellite navigation system, in the second reference frame linked to the antenna, is by definition equal to:

$${\vec{u}}_{n sensor} {=}^{def} [ \begin{matrix}{X}_{n sensor} \\ {Y}_{n sensor} \\ {Z}_{n sensor}\end{matrix} ] / ρ$$

The denominator ρ represents the distance separating the antenna of the receiver and the satellite n, independent of the reference frame:

ρ=\sqrt{Xₙ²+Yₙ²+Zₙ²}=\sqrt{X_{n sensor}²+Y_{n sensor}²+Z_{n sensor}²}

The direction vector of the satellite with index n may thus be expressed as functions of the Euler angles:

$${\vec{u}}_{n sensors} ( ψ , θ , ϕ ) = M ( ψ , θ , ϕ ) \cdot {\vec{u}}_{n TGL}$$

$${\vec{u}}_{n sensors} ( ψ , θ , ϕ ) {=}^{def} [ \begin{matrix}{ux}_{n} ( ψ , θ , ϕ ) \\ {uy}_{n} ( ψ , θ , ϕ ) \\ {uz}_{n} ( ψ , θ , ϕ )\end{matrix} ]$$

The direction of the satellite with index n may also be represented by the elevation angle (σ) and azimuthal angle (γ):

$${\vec{u}}_{n sensors} ( ψ , θ , ϕ ) {=}^{def} [ \begin{matrix}cos ( {γ}_{n} ) \cdot cos ( {σ}_{n} ) \\ sin ( {γ}_{n} ) \cdot cos ( {σ}_{n} ) \\ sin ( {σ}_{n} )\end{matrix} ]$$

$${σ}_{n} ( ψ , θ , ϕ ) = {sin}^{- 1} ( {uz}_{n} ( ψ , θ , ϕ ) )$$

$${γ}_{n} ( ψ , θ , ϕ ) = {tan}^{- 1} ( {ux}_{n} ( ψ , θ , ϕ ) , {uy}_{n} ( ψ , θ , ϕ ) )$$

The assumed phase-shifts of the signals received between the antenna sensors are calculated from the assumed elevation and azimuthal angles.

The difference in optical path between the centre of the second antenna reference frame and the sensor with index m for the signal received from the satellite n is expressed as follows:

$${ɛ}_{m , n} ( ψ , θ , ϕ ) {=}^{def} {\vec{u}}_{n sensors} ( ψ , θ , ϕ ) \cdot {\vec{r}}_{m sensors}$$

The denominator ρ represents the distance separating the antenna of the receiver and the satellite n, which is independent of the reference frame:

Throughout the present application, the presence of an index “def” above an equality sign in a mathematical expression means an equality by definition and not by consequence

As in FIG. 1, the attitude of the antenna is shown with respect to the first TGL reference frame by virtue of the Euler angles: Heading (ψ), Elevation (θ) and Inclination (φ). These angles allow the reference transfer matrix M(ψ, θ, φ) from the first TGL reference frame to the second reference frame linked to the antenna or to the antenna (idem) sensors to be constructed

The direction vector between the antenna of the receiver and the satellite with index n of the satellite navigation system, in the second reference frame linked to the antenna, is by definition equal

The denominator ρ represents the distance separating the antenna of the receiver and the satellite n, independent of the reference frame

The direction vector of the satellite with index n may thus be expressed as functions of the Euler angle

The direction of the satellite with index n may also be represented by the elevation angle (σ) and azimuthal angle

The assumed phase-shifts of the signals received between the antenna sensors are calculated from the assumed elevation and azimuthal angles.

The difference in optical path between the centre of the second antenna reference frame and the sensor with index m for the signal received from the satellite n is expressed as follows

The corresponding phase-shift is expressed as follows:
(in m)

The corresponding phase-shift is expressed as follows:

$${δ}_{m , n} ( ψ , θ , ϕ ) {=}^{def} {\vec{u}}_{n sensors} ( ψ , θ , ϕ ) \cdot {\vec{r}}_{m sensors} \cdot ( 2 π / λ ) ( in rad )$$

λ representing the wavelength of the carrier

By noting

$${\vec{r}}_{m sensors} {=}^{def} [ \begin{matrix}{X}_{m sensor} \\ {Y}_{m sensor} \\ {Z}_{m sensor}\end{matrix} ]$$

the vector position of the sensor m in the sensor reference frame, known for example by virtue of the phase centre measurements at the factory, in one example with four antenna sensors, the following is obtained:

$${\vec{r}}_{1 sensors} = [ \begin{matrix}r \\ 0 \\ 0\end{matrix} ] {\vec{r}}_{2 sensors} = [ \begin{matrix}0 \\ r \\ 0\end{matrix} ] {\vec{r}}_{3 sensors} = [ \begin{matrix}- r \\ 0 \\ 0\end{matrix} ] {\vec{r}}_{4 sensors} = [ \begin{matrix}0 \\ - r \\ 0\end{matrix} ]$$

as illustrated in FIG. 2.

The demodulation of the signals, digitized at the sampling frequency Fe, is carried out by hardware means in a “wired” digital component, ASIC or FPGA. It requires a very high processing frequency which is difficult to achieve by software means. The demodulation is specific to each satellite signal, characterized by its spreading code and its Doppler shift. In the present application, all the signals received by the sensors are demodulated in parallel within each hardware satellite channel.

The demodulation operates by multiplication of the received signal by a complex local carrier and by a real local code then integration of the product over consecutive intervals of time (this is the correlation). There are in fact two correlation channels per received signal: an instantaneous channel with a local code in phase with the received code and a delta channel with a “delta” code or difference between advanced code and retarded code, according to the prior art.

FIG. 3 shows one example of a demodulation with the tracking loops.

The weighted sums of the demodulated signals from the various sensors are carried out using a low-frequency software application (typically Fw=50 Hz).

The role of the complex weighting coefficients is to bring the signals from the sensors into phase at the output of the correlation channels with the aim of obtaining the maximum amplitude after the sum.

The directions of the satellites calculated from the elevation and azimuthal angles are used to determine the weighting coefficients.

The results at the output of the correlators prior to weighting are written:

$${Z}_{P sensors} {=}^{def} [ \begin{matrix}{Z}_{P 1} \\ {Z}_{P 2} \\ {Z}_{P 3} \\ ⋮ \\ {Z}_{PM}\end{matrix} ] {Z}_{Δ sensors} {=}^{def} {[ \begin{matrix}{Z}_{Δ1} \\ {Z}_{Δ2} \\ {Z}_{Δ3} \\ ⋮ \\ {Z}_{Δ M}\end{matrix} ]}_{M \times 1}$$

The weighting on the instantaneous channel is then written:

$${Z}_{P} {=}^{def} {C}_{n}^{T} ( ψ , θ , ϕ ) \cdot {Z}_{P sensors} ( scalar product )$$

$${Z}_{P} {=}^{def} {C}_{1 , n} ( ψ , θ , ϕ ) \cdot {Z}_{P 1} + {C}_{2 , n} ( ψ , θ , ϕ ) \cdot {Z}_{P 2} + … + {C}_{M , n} ( ψ , θ , ϕ ) \cdot {Z}_{PM}$$

The weighting on the Delta channel (code discriminator) is then written:

$${Z}_{Δ} {=}^{def} {C}_{n}^{T} ( ψ , θ , ϕ ) \cdot {Z}_{Δ sensors} ( scalar product )$$

$${Z}_{Δ} {=}^{def} {C}_{1 , n} ( ψ , θ , ϕ ) \cdot {Z}_{Δ1} + {C}_{2 , n} ( ψ , θ , ϕ ) \cdot {Z}_{Δ2} + … + {C}_{M , n} ( ψ , θ , ϕ ) \cdot {Z}_{Δ M}$$

The complex weighting coefficients are then written:

$${C}_{n} ( ψ , θ , ϕ ) {=}^{def} {[ \begin{matrix}{C}_{1 , n} ( ψ , θ , ϕ ) \\ {C}_{2 , n} ( ψ , θ , ϕ ) \\ {C}_{3 , n} ( ψ , θ , ϕ ) \\ ⋮ \\ {C}_{M , n} ( ψ , θ , ϕ )\end{matrix} ]}_{M \times 1}$$

$${C}_{m , n} ( ψ , θ , ϕ ) {=}^{def} {A}_{sensor m} ( {σ}_{n} , {γ}_{n} ) \cdot exp i ( {δ}_{m , n} ( ψ , θ , ϕ ) + {B}_{sensor m} ( {σ}_{n} , {γ}_{n} ) )$$

A_{sensor m}(σₙ, γₙ) representing the relative amplitude due to the sensor m in the direction of the satellite n calculated from the prior knowledge of the antenna radiation diagrams, including the attenuations due to the analogue RF channels.

B_{sensor m}(σₙ, γₙ) representing the phase-shift due to the sensor m in the direction of the satellite n calculated based on the prior knowledge of the antenna radiation diagrams, including the phase-shifts due to the analogue RF channels.

It is possible to identify the bias of the sensors at the factory, but this increases the cost of production of the equipment (calibration means and time spent) and does not allow any compensation for the aging of the sensor.

It is also possible to identify the phase-shifts of the sensors by virtue of the signals from the satellites using a specific processing operation (cf document FR 2972809)

The tracking loops (code and carrier) are constituted by software means because they operate at low frequency (typically, of the order of Fw=50 Hz), they use more complex mathematical functions, and they use various modes (search, transition, tracking, degraded tracking, etc.)

A phase discriminator is used:

Dφ(k)=argument(Z_{P})

Dφ(k)=arc tangent(I_{P},Q_{P}) Z_{P}=I_{P}+j·Q_{P}

I representing the real part, and Q representing the imaginary part

Dφ(k)=θ Z_{P}=ρe^{iθ}

ρ representing the modulus, and θ representing the argument

K representing the index of the resetting period (typically periods of 20 ms for Fw=50 Hz)

A code discriminator is also used:

D_{code}(k)=real part(Z_{Δ}·Z_{P}*) Z_{P}*=conjugate(Z_{P}*)=I_{P}−j·Q_{P}

D_{code}(k)=I_{P}·I_{Δ}+j·(I_{P}·I_{Δ})

A phase-locked loop (PLL) is used:

A_{carrier}(k)=A_{carrier}(k−1)+T·K_{carrier 3}·Dφ(k)·λ_{carrier}/(2π) (in m/s²)

V_{carrier}(k)=V_{carrier}(k−1)+TA_{carrier}(k)+T·K_{carrier 2}·Dφ(k)·λ_{carrier}/(2π) (in m/s)

C_{carrier}(k)=V_{carrier}(k)+K_{carrier 1}·Dφ(k)·λ_{carrier}/(2π) (in m/s)

A delay-locked loop (DLL) is used:

V_{code}(k)=V_{code}(k−1)+TA_{code}(k)+T·K_{code 2}·D_{code}(k)·L_{chip} (in m/s)

C_{code}(k)=V_{code}(k)+K_{code 1}·D_{code}(k)·L_{chip} (in m/s)

With regard to the numerically-controlled oscillators (or NCO):

C_{NCO carrier}(k)=C_{carrier}(k)/λ_{carrier} (in Hz)

C_{NCO code}(k)=(C_{carrier}(k)+C_{code}(k))/L_{chip} (in Hz)

A criterion to be maximized is posed: the sum over all the satellites of the energy of the weighted sums (i.e. after the array formation):

$$Ψ ( ϕ , θ , ψ ) {=}^{def} {\sum }_{n = 1 , … , N} {‖ {Z}_{Pn} ( ϕ , θ , ψ ) ‖}^{2}$$

$$Ψ ( ϕ , θ , ψ ) {=}^{def} {\sum }_{n = 1 , … , N} {‖ {C}_{n}^{T} ( ϕ , θ , ψ ) \cdot {Z}_{P sensors n} ‖}^{2}$$

$$Ψ ( ϕ , θ , ψ ) {=}^{def} {\sum }_{n = 1 , … , N} [ {C}_{n}^{T} ( ϕ , θ , ψ ) \cdot {Z}_{P sensors n} ] \cdot {[ {C}^{T} ( σ , γ ) \cdot {Z}_{P sensors n} ]}^{*}$$

n being the index of the satellite

It is theoretically possible to carry out a systematic search in the domain of the Euler angles: for each hypothesis (ψ,θ,φ) considered, the assumed directions of arrival of the signals are calculated in the second reference frame or sensor reference frame, then the criterion to be maximized. The values of the angles yielding the minimum criterion are chosen.

Nevertheless, a complete search of the domain within which the Euler angles take their values would be very long and costly in processing power:
The heading ψ takes its values within [0,2π] or [0°,360°]
The attitude θ takes its values within [−π,π] or [−180°,180°]
The inclination φ takes its values within [−π,π] or [−180°,180°]

If sampling is done in steps of 10°, that makes 36×36×36=46656 hypotheses to process.

It is preferred to carry out an iterative search by moving towards the maximum at each iteration using the gradient method:

$$[ \begin{matrix}{ψ}_{i + 1} \\ {θ}_{i + 1} \\ {ϕ}_{i + 1}\end{matrix} ] = [ \begin{matrix}{ψ}_{i} \\ {θ}_{i} \\ {ϕ}_{i}\end{matrix} ] + α \cdot \vec{G} rad Φ ( {ψ}_{i} , {θ}_{i} , {ϕ}_{i} )$$

$$\vec{G} rad Ψ ( ψ , θ , ϕ ) = {\sum }_{n = 1 , … , N} [ \begin{matrix}\frac{\partial }{\partial ψ} {‖ {Z}_{Pn} ( ψ , θ , ϕ ) ‖}^{2} \\ \frac{\partial }{\partial θ} {‖ {Z}_{Pn} ( ψ , θ , ϕ ) ‖}^{2} \\ \frac{\partial }{\partial ϕ} {‖ {Z}_{Pn} ( ψ , θ , ϕ ) ‖}^{2}\end{matrix} ]$$

$$\frac{\partial {‖ {Z}_{Pn} ( ψ , θ , ϕ ) ‖}^{2}}{\partial ψ} = \frac{\partial [ {C}_{n}^{T} ( ψ , θ , ϕ ) \cdot {Z}_{P sensors n} ] \cdot {[ {C}_{n}^{T} ( ψ , θ , ϕ ) \cdot {Z}_{P sensors n} ]}^{*}}{\partial ψ}$$

$$\frac{\partial {‖ {Z}_{Pn} ( ψ , θ , ϕ ) ‖}^{2}}{\partial ψ} = Re ( [ \frac{\partial {C}_{n}^{T}}{\partial ψ} ( ψ , θ , ϕ ) \cdot {Z}_{P sensors n} ] \cdot {[ {C}_{n}^{T} ( ψ , θ , ϕ ) \cdot {Z}_{P sensors n} ]}^{*} \\ \vec{G} rad Ψ ( ψ , θ , ϕ ) = {\sum }_{n = 1 , … , N} [ \begin{matrix}Re ( \begin{matrix}[ \frac{\partial {C}_{n}^{T}}{\partial ψ} ( ψ , θ , ϕ ) \cdot {Z}_{P sensors n} ] \cdot \\ {[ {C}_{n}^{T} ( ψ , θ , ϕ ) \cdot {Z}_{P sensors n} ]}^{*}\end{matrix} ) \\ Re ( \begin{matrix}[ \frac{\partial {C}_{n}^{T}}{\partial θ} ( ψ , θ , ϕ ) \cdot {Z}_{P sensors n} ] \cdot \\ {[ {C}_{n}^{T} ( ψ , θ , ϕ ) \cdot {Z}_{P sensors n} ]}^{*}\end{matrix} ) \\ Re ( \begin{matrix}[ \frac{\partial {C}_{n}^{T}}{\partial ϕ} ( ψ , θ , ϕ ) \cdot {Z}_{P sensors n} ] \cdot \\ {[ {C}_{n}^{T} ( ψ , θ , ϕ ) \cdot {Z}_{P sensors n} ]}^{*}\end{matrix} )\end{matrix} ]$$

Notation: Re(z) represents the real part of z

Discriminators are calculated at the output of the correlators in order to measure the errors made on the directions of the satellites.

The direction cosines α and β on the axes X and Y of the antenna reference frame or sensor reference frame may also be taken as parameters for the direction of arrival of the satellite signals.

The direction cosine on the axis Z is deduced by virtue of the norm being equal to 1. In order to avoid any ambiguity over the sign of Z, it must be assumed that the satellites are always situated above the plane of the antenna, and hence the satellites below ignored. This is valid in that the satellites low down in the sensor reference frame are not exploitable for the determination of the directions of arrival due to antenna gains being maladapted to a low angle of elevation.

$${\vec{u}}_{\underline{sensor}} ( α , β ) {=}^{def} [ \begin{matrix}α \\ β \\ \sqrt{1 - {α}^{2} - {β}^{2}}\end{matrix} ] {=}^{def} [ \begin{matrix}ux ( α , β ) \\ uy ( α , β ) \\ uz ( α , β )\end{matrix} ]$$

The phase-shift is calculated for variable direction cosines. The difference in optical path is first of all calculated:

$${ɛ}_{m} ( α , β ) {=}^{def} {\vec{u}}_{sensors} ( α , β ) \cdot {\vec{r}}_{m sensors} ( in m )$$

and the corresponding phase-shift:

$${δ}_{m} ( α , β ) {=}^{def} {\vec{u}}_{sensors} ( α , β ) \cdot {\vec{r}}_{m sensors} \cdot ( 2 π / λ ) ( in rad )$$

This leads to the complex weighting coefficients:

$${C}_{n} ( α , β ) {=}^{def} {[ \begin{matrix}{C}_{1 , n} ( α , β ) \\ {C}_{2 , n} ( α , β ) \\ {C}_{3 , n} ( α , β ) \\ ⋮ \\ {C}_{M , n} ( α , β )\end{matrix} ]}_{M \times 1}$$

$${C}_{m , n} ( α , β ) {=}^{def} {A}_{sensor m} ( σ ( α , β ) , γ ( α , β ) ) \cdot exp i ( {δ}_{m} ( α , β ) + {B}_{sensor m} ( σ ( α , β ) , γ ( α , β ) ) )$$

$$σ ( α , β ) = {tan}^{- 1} ( \sqrt{{α}^{2} + {β}^{2}} , \sqrt{1 - {α}^{2} + {β}^{2}} )$$

$$γ ( α , β ) = {tan}^{- 1} ( α , β )$$

The use of the index n is obviated because the position of the satellite is no longer involved as soon as the variable direction cosines α and β are used.

The derivatives, with respect to the direction cosines, of the powers of the weighted complex sums involves the real part of the products of “delta” weighted sums with the complex conjugate of the “instantaneous” weighted sum:

$$\frac{\partial {‖ {Z}_{Pn} ( α , β ) ‖}^{2}}{\partial α} = \frac{\partial [ {C}_{n}^{T} ( α , β ) \cdot {Z}_{P sensors n} ] \cdot {[ {C}_{n}^{T} ( α , β ) \cdot {Z}_{P sensors n} ]}^{*}}{\partial α}$$

$$\frac{\partial {‖ {Z}_{Pn} ( α , β ) ‖}^{2}}{\partial α} = 2 \cdot Re ( [ \frac{\partial {C}_{n}^{T}}{\partial α} ( α , β ) \cdot {Z}_{P sensors n} ] \cdot {[ {C}_{n}^{T} ( α , β ) \cdot {Z}_{P sensors n} ]}^{*} )$$

$$\frac{\partial {‖ {Z}_{Pn} ( α , β ) ‖}^{2}}{\partial α} = 2 \cdot Re ( {Z}_{an} ( α , β ) \cdot {{Z}_{Pn} ( α , β )}^{*} )$$

Based on this principle, in accordance with FIG. 4 direction cosine error discriminators are calculated:

$${D}_{an} ( α , β ) {=}^{def} Re [ {Z}_{an} ( α , β ) \cdot {{Z}_{Pn} ( α , β )}^{*} ] / {‖ Z ‖}^{2} / {ρ}_{a} = Re ( {Z}_{a} / {Z}^{*} ) / {ρ}_{a}$$

$${D}_{bn} ( α , β ) {=}^{def} Re [ {Z}_{bn} ( α , β ) \cdot {{Z}_{Pn} ( α , β )}^{*} ] / {‖ Z ‖}^{2} / {ρ}_{b} = Re ( {Z}_{b} / {Z}^{*} ) / {ρ}_{b}$$

The “instantaneous” weighted sum is used:

$${Z}_{Pn} ( α , β ) {=}^{def} {C}^{T} ( α , β ) \cdot {Z}_{Pn sensors}$$

and the “delta” weighted sums are used:

$${Z}_{an} ( α , β ) {=}^{def} {C}_{a}^{T} ( α , β ) \cdot {Z}_{Pn sensors}$$

$${C}_{a} ( α , β ) {=}^{def} \frac{\partial {C}^{T}}{\partial α} ( α , β )$$

$${Z}_{bn} ( α , β ) {=}^{def} {C}_{b}^{T} ( α , β ) \cdot {Z}_{Pn sensors}$$

$${C}_{b} ( α , β ) {=}^{def} \frac{\partial {C}^{T}}{\partial β} ( α , β )$$

In order to calculate the sensitivity of the discriminators, the following is posed:

$$Π ( α , β ) {=}^{def} {C}^{T} ( α , β ) \cdot C ( {α}_{0} , {β}_{0} )$$

$${Δ}_{a} ( α , β ) {=}^{def} \frac{\partial {C}^{T}}{\partial α} ( α , β ) \cdot C ( {α}_{0} , {β}_{0} )$$

$${Δ}_{b} ( α , β ) {=}^{def} \frac{\partial {C}^{T}}{\partial β} ( α , β ) \cdot C ( {α}_{0} , {β}_{0} )$$

The signal received is expressed:

Z_{P sensors}=C(αₜᵣᵤₑ,βₜᵣᵤₑ)·T·\sqrt{P}+noise

P representing the power of the received signal, and

T representing the coherent integration time

The vector C(αₜᵣᵤₑ,βₜᵣᵤₑ) is representative of the complex amplitudes received on each sensor. The angles (αₜᵣᵤₑ,βₜᵣᵤₑ) corresponds to the true direction hence to the maximum of Ψ(α,β). Under the assumption that (αₜᵣᵤₑ,βₜᵣᵤₑ) is known, by posing (α₀,β₀)=(αₜᵣᵤₑ,βₜᵣᵤₑ) the following is obtained:

$$Z ( α , β ) = {C}^{T} ( α , β ) \cdot C ( {α}_{true} , {β}_{true} ) \cdot T \cdot \sqrt{P}$$

$${Z}_{a} ( α , β ) = \frac{\partial {C}^{T}}{\partial α} ( α , β ) \cdot C ( {α}_{true} , {β}_{true} ) \cdot T \cdot \sqrt{P}$$

$${Z}_{b} ( α , β ) = \frac{\partial {C}^{T}}{\partial β} ( α , β ) \cdot C ( {α}_{true} , {β}_{true} ) \cdot T \cdot \sqrt{P}$$

Under the assumption that (αₜᵣᵤₑ,βₜᵣᵤₑ) is known, by posing (α₀,β₀)=(αₜᵣᵤₑ,βₜᵣᵤₑ) the following is obtained:

Z(α,β)=Π(α,β)·T·\sqrt{P}

Zₐ(α,β)=Δₐ(α,β)·T·\sqrt{P}

Z_{b}(α,β)=Δ_{b}(α,β)·T·\sqrt{P}

leading to:

Dₐ(α,β)=Re[Δₐ·Π]/∥Π∥²/ρₐ

D_{b}(α,β)=Re[Δ_{b}·Π]/∥Π∥²/ρ_{b}

In order to normalize the sensitivity of the discriminators to 1, the following is posed:

$${ρ}_{a} {=}^{def} \frac{\partial }{\partial α} ( Re [ {Δ}_{a} \cdot Π ] / {‖ Π ‖}^{2} ) ( {α}_{0} , {β}_{0} )$$

$${ρ}_{b} {=}^{def} \frac{\partial }{\partial β} ( Re [ {Δ}_{b} \cdot Π ] / {‖ Π ‖}^{2} ) ( {α}_{0} , {β}_{0} )$$

for values (α₀,β₀) corresponding to the latest estimated values of (α,β)

Thus, if the values of (α, β) are close to the true values (α_{true n}, β_{true n}):

D_{a n}(α,β)≅(α−α_{true n})+noise

D_{b n}(α,β)≅(β−β_{true n})+noise

An observational model is also used.

Since the relationship between the direction cosines (αₙ,βₙ) and the Euler angles (ψ,θ,φ) is not linear, this relationship is linearized about a point of operation (ψ,ω,φ) in order to establish a linear observational model:

$$d {α}_{n} {=}^{def} {α}_{n} ( ψ + d ψ , θ + d θ , ϕ + d ϕ ) - {α}_{n} ( ψ , θ , ϕ )$$

$$d {β}_{n} {=}^{def} {β}_{n} ( ψ + d ψ , θ + d θ , ϕ + d ϕ ) - {β}_{n} ( ψ , θ , ϕ )$$

$$d {α}_{n} = \frac{\partial {ux}_{n}}{\partial ψ} ( ψ , θ , ϕ ) \cdot d ψ + \frac{\partial {ux}_{n}}{\partial θ} ( ψ , θ , ϕ ) \cdot d θ + \frac{\partial {ux}_{n}}{\partial ϕ} ( ψ , θ , ϕ ) \cdot d ϕ$$

$$d {β}_{n} = \frac{\partial {uy}_{n}}{\partial ψ} ( ψ , θ , ϕ ) \cdot d ψ + \frac{\partial {uy}_{n}}{\partial θ} ( ψ , θ , ϕ ) \cdot d θ + \frac{\partial {uy}_{n}}{\partial ϕ} ( ψ , θ , ϕ ) \cdot d ϕ$$

For the calculation of the partial derivatives, the finite difference method can be used:

$$\frac{\partial {ux}_{n}}{\partial ψ} ( ψ , θ , ϕ ) = ( \partial {ux}_{n} ( ψ + d ψ , θ , ϕ ) - \partial {ux}_{n} ( ψ , θ , ϕ ) ) / d ψ$$

Using Other Notations:

dαₙ=α_{n,1}·dψ+α_{n,2}·dθ+α_{n,3}·dφ

dβₙ=b_{n,1}·dψ+b_{n,2}·dθ+b_{n,3}·dφ

If all the visible satellites are considered, there are 2.N equations for 3 unknowns.

$$[ \begin{matrix}d {α}_{1} \\ d {β}_{1} \\ ⋮ \\ d {α}_{N} \\ d {β}_{N}\end{matrix} ] = [ \begin{matrix}{a}_{1 , 1} & {a}_{1 , 2} & {a}_{1 , 3} \\ {b}_{1 , 2} & {b}_{1 , 2} & {b}_{1 , 3} \\ ⋮ & ⋮ & ⋮ \\ {a}_{N , 1} & {a}_{N , 2} & {a}_{N , 3} \\ {b}_{N , 1} & {b}_{N , 2} & {b}_{N , 3}\end{matrix} ] [ \begin{matrix}d ϕ \\ d θ \\ d ψ\end{matrix} ]$$

being:

$$[ \begin{matrix}d {α}_{1} \\ d {β}_{1} \\ ⋮ \\ d {α}_{N} \\ d {β}_{N}\end{matrix} ] = H [ \begin{matrix}d ϕ \\ d θ \\ d ψ\end{matrix} ] with H = [ \begin{matrix}{a}_{1 , 1} & {a}_{1 , 2} & {a}_{1 , 3} \\ {b}_{1 , 2} & {b}_{1 , 2} & {b}_{1 , 3} \\ ⋮ & ⋮ & ⋮ \\ {a}_{N , 1} & {a}_{N , 2} & {a}_{N , 3} \\ {b}_{N , 1} & {b}_{N , 2} & {b}_{N , 3}\end{matrix} ]$$

The idea is to get back to the errors on the Euler angles (dψ=ψ−ψₜᵣᵤₑ, dθ=θ−θₜᵣᵤₑ, dφ=φ−φₜᵣᵤₑ) starting from the errors on the direction cosines (dαₙ=αₙ(φ,θ,φ)−α_{true n}, dβₙ=βₙ(φ,θ,φ)−β_{true n})

The errors on the direction cosines are observable thanks to the discriminators:

dαₙ=αₙ(ψ,θ,φ)−α_{true n}=D_{a n}(αₙ(ψ,θ,φ),βₙ(ψ,θ,φ))+noise

dβₙ=βₙ(ψ,θ,φ)−β_{true n}=D_{b n}(αₙ(ψ,θ,φ),βₙ(ψ,θ,φ))+noise

A solution by least squares may also be used:

$$[ \begin{matrix}d {ϕ}_{estimated} \\ d {θ}_{estimated} \\ d {ψ}_{estimated}\end{matrix} ] = H * [ \begin{matrix}d {α}_{1} \\ d {β}_{1} \\ ⋮ \\ d {α}_{N} \\ d {β}_{N}\end{matrix} ]$$

with H*=(H^{T}W^{T}WH)⁻¹H^{T}W^{T} for pseudo-inverse.

The matrix W allows the measurements to be weighted as a function of the signal-to-noise estimated on each satellite signal.

$$\begin{matrix}W = [ \begin{matrix}1 / {σ}_{a 1}^{2} & 0 & … & … & 0 \\ 0 & 1 / {σ}_{b 1}^{2} & … & & ⋮ \\ ⋮ & … & … & … & ⋮ \\ ⋮ & & … & 1 / {σ}_{aN}^{2} & 0 \\ 0 & … & … & 0 & 1 / {σ}_{bN}^{2}\end{matrix} ] & \\ {σ}_{an}^{2} = {σ}_{bn}^{2} = \frac{1}{C / {N}_{0 estimated n}} & \end{matrix}$$

After the solution, the previously estimated Euler angles are corrected:

$$[ \begin{matrix}{ϕ}_{estimated} \\ {θ}_{estimated} \\ {ψ}_{estimated}\end{matrix} ] = [ \begin{matrix}{ϕ}_{estimated preceding} \\ {θ}_{estimated preceding} \\ {ψ}_{estimated preceding}\end{matrix} ] + [ \begin{matrix}d {ϕ}_{estimated} \\ d {θ}_{estimated} \\ d {ψ}_{estimated}\end{matrix} ]$$

As a variant to the least squares, a solution by Kalman filter (extended) may be used, as follows:

State:

$$Real \text{:} {X}_{i} = ⌊ \begin{matrix}{ϕ}_{i} \\ {θ}_{i} \\ {ψ}_{i}\end{matrix} ⌋$$

$$Estimated \text{:} {X}_{i / i} = [ \begin{matrix}{ϕ}_{estimated i} \\ {θ}_{estimated i} \\ {ψ}_{estimated i}\end{matrix} ]$$

at time i

Initialization:

$${X}_{0 / 0} = [ \begin{matrix}{ϕ}_{estimated initial} \\ {θ}_{estimated initial} \\ {ψ}_{estimated initial}\end{matrix} ]$$

$${P}_{0 / 0} = [ \begin{matrix}∞ & 0 & 0 \\ 0 & ∞ & 0 \\ 0 & 0 & ∞\end{matrix} ]$$

Propagation:

$${X}_{i / i - 1} = {X}_{i - 1 / i - 1}$$

$$Propagated state vector$$

$${P}_{i / i - 1} = {P}_{i - 1 / i - 1} + {Q}_{i}$$

$$Propagated covariance matrix$$

$${Q}_{i} = [ \begin{matrix}{q}_{ϕ} & 0 & 0 \\ 0 & {q}_{θ} & 0 \\ 0 & 0 & {q}_{ψ}\end{matrix} ]$$

$$State noise$$

The state noise is chosen as a function of the dynamic behaviour of the attitude of the carrier.

Resetting:

$${Y}_{i} = [ \begin{matrix}d {α}_{1} \\ d {β}_{1} \\ ⋮ \\ d {α}_{N} \\ d {β}_{N}\end{matrix} ]$$

$${H}_{i} = [ \begin{matrix}{a}_{1 , 1} & {a}_{1 , 2} & {a}_{1 , 3} \\ {b}_{1 , 2} & {b}_{1 , 2} & {b}_{1 , 3} \\ ⋮ & ⋮ & ⋮ \\ {a}_{N , 1} & {a}_{N , 2} & {a}_{N , 3} \\ {b}_{N , 1} & {b}_{N , 2} & {b}_{N , 3}\end{matrix} ]$$

$${R}_{i} = [ \begin{matrix}{σ}_{a 1}^{2} & 0 & … & … & 0 \\ 0 & {σ}_{b 1}^{2} & … & & ⋮ \\ ⋮ & … & … & … & ⋮ \\ ⋮ & & … & {σ}_{aN}^{2} & 0 \\ 0 & … & … & 0 & {σ}_{bN}^{2}\end{matrix} ]$$

The innovation Yᵢ=Zᵢ−HX_{i/i-1} is already contained in the discriminators, so it is not necessary to recalculate it.

Kᵢ=(HᵢP_{i/i-1}Hᵢ^{T}+Rᵢ)⁻¹P_{i/i-1}Hᵢ^{T} Resetting gain

X_{i/i}=X_{i/i-1}+Kᵢ·Yᵢ Reset state vector

P_{i/i}=(Id−KᵢHᵢ)·P_{i/i-1} Reset covariance matrix

The schematic overview in FIG. 5 illustrates the above steps.

FIG. 6 illustrates a receiver 20 for signals from a satellite navigation system, equipped with an antenna 21 using controlled reception pattern sensors, comprising array formation means 22 in order to improve the resistance to scrambling or interference, comprising means 23 for determining the attitude of the antenna in a TGL reference frame centred on the receiver, by iterative determination of the attitude angles of the antenna yielding the maximum of the sum of the energies of the weighted sums of the signals received by the sensors at the output of the correlators of the processing channel respectively associated with the satellites, the weighting coefficients of the weighted sums being calculated from the attitude angles considered at each iteration and from the known positions of the satellites in the TGL reference frame.

Such a receiver implements the method previously described.

In the present application, the notations used have the definitions:

expi(φ)=exp(j·φ)=e^{jφ} (j²=−1)

### DEFINITIONS

Fᵣ: Residual frequency of the digitized signals in base band (Fᵣ small compared to Fe)

Dopₙ: Doppler shift of the satellite signal n

φ_{m,n}: Phase-shift of the satellite signal n on the sensor m

Cₙ(t): spreading code for the satellite n

Retₙ: Delay of the satellite signal n

R(τ): Autocorrelation function for the code

R(τ)=1−|τ| if |τ|<1 R(τ=0)=1

R(τ)=0 otherwise

R_{n,n}(t)=1/L∫_{[kL,(k+1)L]}Cₙ(u)·Cₙ(u+τ)du=R(τ) for large L(>1000) and for any value of k

R_{n,p}(t)=1/L∫_{[kL,(k+1)L]}Cₙ(u)·Cₚ(u+τ)du≅0 if p≠n

Signals Received:

The signal received on the antenna is the sum of the signals received from the visible satellites plus noise

S_{received m}(t)=_{n=1, . . . , N}S_{received m,n}(t)+noise

Signal received from the satellite n on the sensor m:

S_{received m,n}(t)=A·expi(φ_{received carrier m,n}(t))·Cₙ(φ_{received code n}(t))

S_{received m,n}(t)=A·expi(2π·(Fᵣ+Dopₙ)·t+θ_{m,n})·Cₙ(F_{code}·(t+Retₙ))

Local Signal in the Channel n:

S_{local n}(t)=expi(−φ_{local carrier n}(t))·Cₙ(φ_{local code n}(t))

S_{local n}(t)=expi(−2π·(Fᵣ+Dopₙ)·t−θₙ)·Cₙ(F_{code}·(t+Retₙ)+τ)

Correlations:

Z_{m,n}=1/T∫_{[kT,(k+1)T]}S_{received m}(t)·S_{local n}(t)dt

T: coherent integration time (typically T=20 ms)

Since the satellite codes are decorrelated (R_{n,p}(τ)≅0), it is possible to write:

Z_{m,n}(k)=1/T∫_{[kT,(k+1)T]}S_{received m,n}(t)·S_{local n}(t)dt+noise

Z_{m,n}(k)=1/T∫_{[kT,(k+1)T]}expi(φ_{received port m,n}(t)−φ_{local port n}(t))·Cₙ(φ_{received code n}(t))·Cₙ(φ_{local code n}(t))·dt

Z_{m,n}(k)=A·expi(θ_{m,n}−θₙ)·1/L∫_{[kL,(k+1)L]}Cₙ(u+τ)·Cₙ(u)du+noise

Z_{m,n}(k)=A·expi(θ_{m,n}−θₙ)·R(τ)+noise

It is assumed that the local code of the channel n is in phase with the code received from the satellite n, thanks to the delay-locked loop according to the prior art. This leads to τ=0 and R(τ)=1

Z_{m,n}(k)=A·expi(θ_{m,n}−θₙ)+noise

1. Method for formation of a signals array from a receiver (20) of signals from a satellite navigation system in order to improve the resistance to scrambling or interference, the receiver (20) being equipped with an antenna (21) having several controlled reception pattern sensors, comprising a step consisting in determining the attitude of the antenna in a TGL reference frame centred on the receiver, by iterative determination of the attitude angles of the antenna yielding the maximum of the sum of the energies of the weighted sums of the signals received by the sensors at the output of the correlators of the processing channel respectively associated with the satellites, the weighting coefficients of the weighted sums being calculated from the attitude angles considered at each iteration and from the known positions of the satellites in the TGL reference frame.

2. Method according to claim 1, in which parameter discriminators are used that are representative of the directions of arrival of the satellite signals in a reference frame linked to the antenna.

3. Method according to claim 2, in which a method is used based on an observational model of the relationship between the parameters representative of the directions of arrival of the satellite signals and the attitude angles of the antenna.

4. Method according to claim 3, in which the solution based on an observational model implements a Kalman filtering.

5. Method according to claim 3, in which the solution based on an observational model implements a least squares method.

6. Method according to claim 2, in which the said parameters representative of the directions of arrival of the satellite signals in a reference frame linked to the antenna comprise direction cosines or elevation and azimuthal angles.

7. Method according to claim 6, in which a method is used based on an observational model of the relationship between the parameters representative of the directions of arrival of the satellite signals and the attitude angles of the antenna.

8. Method according to claim 7, in which the solution based on an observational model implements a Kalman filtering.

9. Method according to claim 7, in which the solution based on an observational model implements a least squares method.

10. Receiver (20) for signals from a satellite navigation system, equipped with an antenna (21) using controlled reception pattern sensors, comprising means (22) for formation of arrays in order to improve the resistance to scrambling or interference, comprising means (23) for determining the attitude of the antenna in a TGL reference frame centred on the receiver, by iterative determination of the attitude angles of the antenna yielding the maximum of the sum of the energies of the weighted sums of the signals received by the sensors at the output of the correlators of the processing channel respectively associated with the satellites, the weighting coefficients of the weighted sums being calculated from the attitude angles considered at each iteration and from the known positions of the satellites in the TGL reference frame.
